(19) United States
(12) Patent Application Publication
(10) Pub. No.: US 2026/0221910 A1
(43) Pub. Date: Jul. 30, 2026

(54) Power Conversion Device and Drive Device

(71) Applicant: Astemo, Ltd., Chiyoda-ku, Tokyo (JP)

(72) Inventors: Ryoichi INADA, Tokyo (JP); Satoru SHIGETA, Hitachinaka-shi, Ibaraki (JP); Hiroshi NAKANO, Tokyo (JP); Nobuyasu KANEKAWA, Tokyo (JP)

(21) Appl. No.: 19/146,394

(22) PCT Filed: Oct. 12, 2023
(86) PCT No.: PCT/JP2023/037021

§ 371 Date: Jul. 8, 2025

(30) Foreign Application Priority Data
Feb. 27, 2023 (JP) 2023-028886

(51) Int. Cl. H02P 21/22; H02P 21/14

(52) U.S. Cl. CPC H02P 21/22; H02P 21/14

(57) ABSTRACT

A power conversion device includes: a power conversion circuit that converts DC power into AC power through PWM control, and outputs three-phase AC currents to a motor; a three-phase/two-phase conversion unit that converts the three-phase AC currents into dq-axis currents; a DC voltage detection unit that detects a DC voltage value of the DC power; and a first compute unit that calculates dq-axis voltages based on motor parameters of the motor and the dq-axis currents, and calculates a first DC current value of the DC power based on the dq-axis voltages, the dq-axis currents, and the DC voltage value.

### TECHNICAL FIELD

The present invention relates to a power conversion device and a drive device.

### BACKGROUND ART

In a vehicle using a motor for vehicle traveling, such as a hybrid vehicle or an electric vehicle, the motor or the like is driven by converting DC power supplied from a DC power supply into AC power using an in-vehicle power conversion device. In such a power conversion device, in order to monitor the state of the DC power supply and diagnose the inside of the power conversion device, there has been known a technique for calculating a DC current supplied from the DC power supply to the power conversion device.

For example, PTL 1 discloses a technique in which AC power is calculated from dq-axis voltage commands and dq-axis current commands, and a DC current is calculated based on the AC power. In addition, PTL 2 discloses a technique in which a DC current is calculated using an AC current value and a duty value.

### CITATION LIST

### Patent Literature

PTL 1: JP 2006-33970 A
PTL 2: JP 2017-208893 A

### SUMMARY OF INVENTION

### Technical Problem

However, if the power conversion circuit fails and a voltage cannot be output according to the command, the command deviates from the actual output voltage. Therefore, in a method of calculating a DC current using a value corresponding to a command such as a voltage command value or a duty value as in the techniques described in PTL 1 and PTL 2, there is a problem that a correct DC current value cannot be calculated.

### Solution to Problem

A power conversion device according to an aspect of the present invention includes: a power conversion circuit that converts DC power into AC power through PWM control, and outputs three-phase AC currents to a motor; a three-phase/two-phase conversion unit that converts the three-phase AC currents into dq-axis currents; a DC voltage detection unit that detects a DC voltage value of the DC power; and a first compute unit that calculates dq-axis voltages based on motor parameters of the motor and the dq-axis currents, and calculates a first DC current value of the DC power based on the dq-axis voltages, the dq-axis currents, and the DC voltage value.

A drive device according to an aspect of the present invention includes a motor, and the above-described power conversion device that converts DC power into AC power through PWM control, and supplies three-phase AC currents to the motor.

### Advantageous Effects of Invention

According to the present invention, it is possible to calculate a correct DC current value even in a state where the power conversion circuit has failed.

### BRIEF DESCRIPTION OF DRAWINGS

FIG. 1 is a schematic diagram of a vehicle.

FIG. 2 is a diagram illustrating a schematic configuration of a drive device.

FIG. 3 is a diagram illustrating an example of a configuration of a power conversion circuit.

FIG. 4 is a control block diagram illustrating functions of a control circuit in detail.

FIG. 5 is a diagram for explaining a second embodiment of the present invention.

FIG. 6 is a diagram illustrating a correspondence between an operation state and a DC current calculation value to be selected.

FIG. 7 is a diagram illustrating an example of an operation of a selection unit.

FIG. 8 is a diagram illustrating an example of a case where a switching operation is performed in multiple stages.

FIG. 9 is a diagram for explaining a third embodiment of the present invention.

FIG. 10 is a diagram for explaining an operation of a selection unit in the third embodiment.

### DESCRIPTION OF EMBODIMENTS

Hereinafter, embodiments for carrying out the present invention will be described with reference to the drawings. The following description and drawings are examples for describing the present invention, and some omissions and simplifications will be made as appropriate for clarity of explanation. In the following description, the same or similar elements and processes will be denoted by the same reference signs, and redundant description may be omitted. Note that examples of embodiments of the present invention are merely described below, and the present invention is not limited to the following embodiments, and can be implemented in other various forms.

### First Embodiment

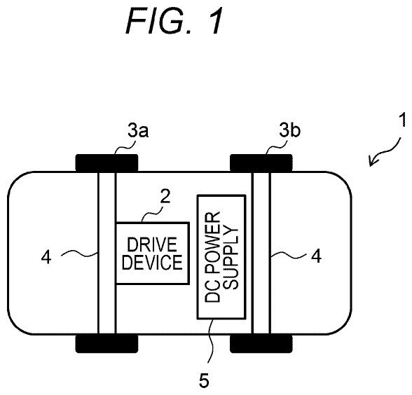

A first embodiment of the present invention will be described with reference to FIGS. 1 to 4. FIG. 1 is a schematic diagram of a vehicle traveling by a motor (not illustrated). The vehicle 1 includes a drive device 2 to which electric power is supplied from a DC power supply 5. Although not illustrated, the drive device 2 includes a power conversion device, a motor, and a speed reducer. A driving force of the motor is transmitted, via the speed reducer, to an axle 4 on which wheels 3a are provided.

In the example illustrated in FIG. 1, the drive device 2 is installed on the axle 4 for front wheels (wheels 3a), but may be installed on an axle for rear wheels (wheels 3b). In addition, drive devices 2 may be installed on the respective axles 4 for the front and rear wheels, or independent drive devices 2 may be installed on the left and right wheels 3a and 3b, respectively, instead of the axles. In addition, in addition to the drive device 2 illustrated in FIG. 1, a drive device using an internal combustion engine may be installed on the axle 4 in parallel with the drive device 2.

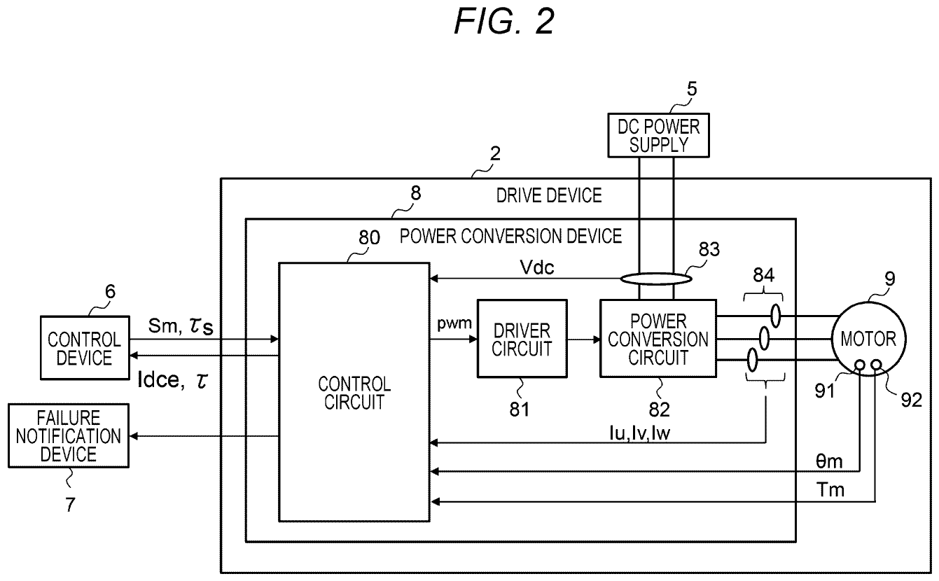

FIG. 2 is a diagram illustrating a schematic configuration of the drive device 2. A DC power supply 5, a control device 6, and a failure notification device 7 are provided around the drive device 2. The control device 6 transmits a target torque τs, operation mode information Sm, etc. to the drive device 2.

In addition, the control device 6 receives an output torque calculation value t and a DC current calculation value Idc output from the drive device 2. Although only one control device 6 is described in the present embodiment, a plurality of control devices may transmit and receive information. The control device 6 also has a function of controlling the drive device using the internal combustion engine described above.

The DC power supply 5 is a power supply for driving a motor 9 in the drive device 2, and corresponds to, for example, a battery. The failure notification device 7 receives a failure detection signal Sf from the drive device 2, and notifies a passenger of an occurrence of a failure. As an example of a way of notifying the failure, a ramp may be turned on, a warning sound may be generated, or a voice notification may be provided.

The drive device 2 includes a power conversion device 8, a motor 9, and a speed reducer (not illustrated). The speed reducer amplifies the driving force of the motor 9 and transmits the amplified driving force to the axle 4 (or wheels 3a or 3b). The motor 9 is a three-phase motor having three windings inside, and corresponds to, for example, a synchronous motor using a permanent magnet or an induction motor not using a permanent magnet.

The motor 9 includes a motor angle sensor 91 and a motor temperature sensor 92. The motor angle sensor 91 measures a rotation angle of a motor rotor, and outputs the measured angle to the power conversion device 8 as a motor angle sensor value Om. The motor temperature sensor 92 measures a temperature of the motor 9, and outputs the measured temperature to the power conversion device 8 as a motor temperature sensor value Tm.

The power conversion device 8 converts DC power supplied from the DC power supply 5 into AC power based on the target torque or the like input from the control device 6, and supplies the AC power to the motor 9. The power conversion device 8 also has a function of converting power from the motor 9 into DC power to charge the DC power supply 5.

The power conversion device 8 includes a control circuit 80, a driver circuit 81, a power conversion circuit 82, a DC voltage sensor 83, and an AC current sensor 84. The control circuit 80 generates a pulse width modulation (PWM) signal pwm for controlling a current in each of the U, V, and W phases output from the power conversion device 8 to a predetermined value based on the target torque τs and the operation mode information Sm from the control device 6. Note that the control circuit 80 will be described in detail later. The driver circuit 81 outputs a drive signal for switching on/off a plurality of power semiconductors provided in the power conversion circuit 30 based on the PWM signal pwm output from the control circuit 80.

The DC voltage sensor 83 is a sensor that measures an output voltage of the DC power supply 5, and outputs the measured voltage value to the control circuit 80 as a DC voltage sensor value Vdc. The AC current sensor 84 is a sensor that measures an AC current flowing through each of the phases (U phase, V phase, and W phase) of the motor 9. The AC current values in the respective phases measured by the AC current sensor 84 are input to the control circuit 80 as AC current sensor values Iu, Iv, and Iw. In the example illustrated in FIG. 2, the AC current sensor 84 includes one sensor for each phase, but may be provided for only two phases. Since the relationship “U-phase current+V-phase current+W-phase current=0” is established, in a configuration in which sensors are provided for two phases, the control circuit 80 calculates an AC current sensor value for the remaining one phase.

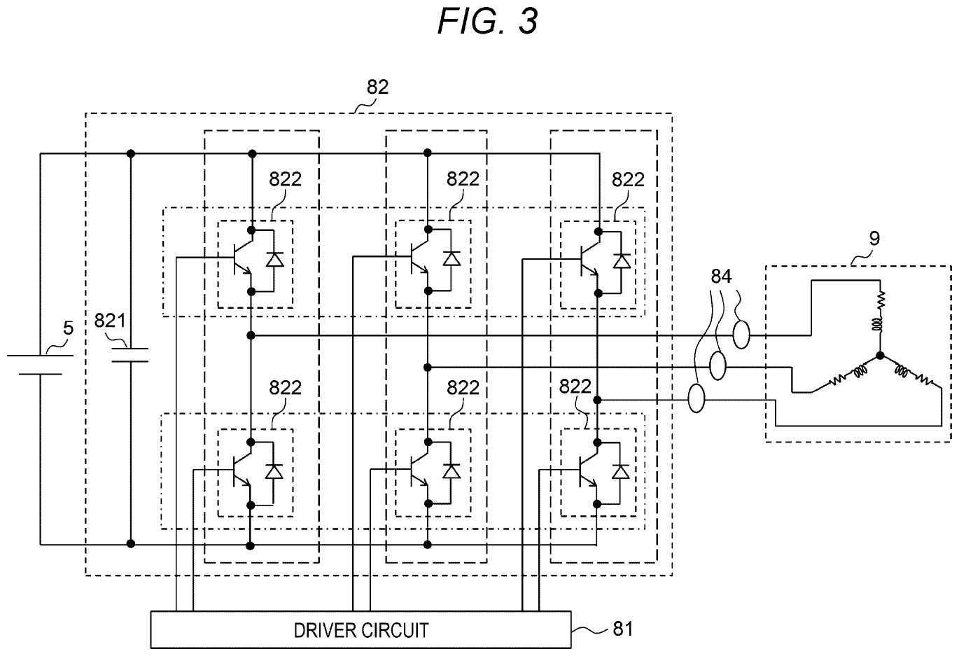

The power conversion circuit 82 receives the drive signal from the driver circuit 81 to drive power semiconductors therein and control a current flowing through the motor 9. FIG. 3 is a diagram illustrating an example of a configuration of the power conversion circuit 82. The power conversion circuit 82 includes a smoothing capacitor 821 and six power semiconductors 822 therein. Two power semiconductors 822 constituting upper and lower arms are provided for each of the phases (U phase, V phase, and W phase). Output terminals of the upper and lower arms for each phase are connected to windings for the corresponding phase of the motor 9.

The power semiconductor 822 is switched on/off according to the drive signal input from the driver circuit 81, and performs conversion between DC power and AC power. The power semiconductor 822 corresponds to, for example, a power metal oxide semiconductor field effect transistor (MOSFET), an insulated gate bipolar transistor (IGBT), or the like. In the example illustrated in FIG. 3, an IGBT is used as the power semiconductor 822.

The smoothing capacitor 821 is a capacitor for smoothing a current generated by turning on/off the power semiconductor 822 and suppressing a ripple in the DC current supplied from the DC power supply 5 to the power conversion circuit 82. As the smoothing capacitor 821, for example, an electrolytic capacitor or a film capacitor is used.

In the present embodiment, the motor neutral point is in a floating state, but may be connected to the ground (not illustrated). Methods for connecting the motor neutral point to the ground include a direct grounding method, a resistance grounding method, a compensation reactor grounding method, and an arc-extinguishing reactor grounding method.

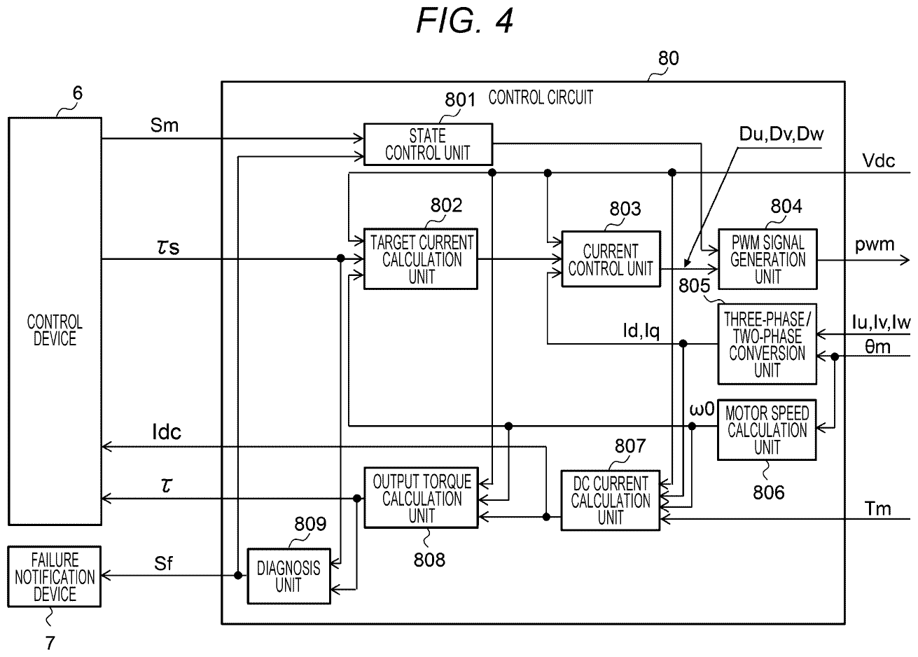

FIG. 4 is a control block diagram illustrating functions of the control circuit 80 in detail. The control circuit 80 includes a central processing unit (CPU), a random access memory (RAM), a read only memory (ROM), a communication circuit, and the like (not illustrated). The CPU develops a program stored in the ROM into the RAM and executes the program, thereby implementing a function of each unit to be described later. The ROM may be an electrically erasable programmable ROM (EEPROM) or a flash ROM that is electrically rewritable.

The control circuit 80 includes a state control unit 801, a target current calculation unit 802, a current control unit 803, a PWM signal generation unit 804, a three-phase/two-phase conversion unit 805, a motor speed calculation unit 806, a DC current calculation unit 807, an output torque calculation unit 808, and a diagnosis unit 809.

The motor speed calculation unit 806 calculates a motor angular velocity ω0 from a change in motor angle sensor value θm. The calculated motor angular velocity ω0 is input to the target current calculation unit 802, the DC current calculation unit 807, and the output torque calculation unit 808.

Based on the motor angle sensor value θm, the three-phase/two-phase conversion unit 805 performs dq conversion as shown in the following equation (1) on the AC current sensor values Iu, Iv, and Iw in the three phases, and calculates a d-axis current value Id and a q-axis current value Iq. The calculated d-axis current value Id and q-axis current value Iq are output to the current control unit 803 and the DC current calculation unit 807.

$$[ Mathematical formula 1 ]$$

$$[ \begin{matrix}{I}_{d} \\ {I}_{q}\end{matrix} ] = \sqrt{\frac{2}{3}} [ \begin{matrix}cos ( θ ) & cos ( θ - \frac{2}{3} - π ) & cos ( θ + \frac{2}{3} π ) \\ - sin ( θ ) & - sin ( θ - \frac{2}{3} π ) & - sin ( θ + \frac{2}{3} π )\end{matrix} ] [ \begin{matrix}{I}_{u} \\ {I}_{v} \\ {I}_{w}\end{matrix} ] \qquad ( 1 )$$

In Equation (1), Iu, Iv, and Iw are AC current sensor values in the U phase, the V phase, and the W phase measured by the AC current sensor 84, respectively. θ is an electrical angle of the motor 9. The electrical angle θ can be calculated by multiplying the motor angle sensor value Om measured by the motor angle sensor 91 by the number of pole pairs of the motor 9. In Equation (1), dq conversion calculation is performed using an absolute conversion coefficient, but the dq conversion calculation may be performed using a relative conversion coefficient.

The state control unit 801 transitions the operation state of the power conversion device 8 using the operation mode information Sm and the failure detection signal Sf output from the diagnosis unit 809, and outputs the current operation state to the PWM signal generation unit 804. Examples of the operation state include a PWM state, a three-phase short-circuit state, and a three-phase open state.

The target current calculation unit 802 calculates a target current value necessary for the motor 9 to output a torque that is the same as the target torque τs, using the target torque τs, the DC voltage sensor value Vdc, and the motor angular velocity ω0. The target current value is output to the current control unit 803. The target current value is expressed in the form of, for example, a d-axis target current value and a q-axis target current value.

Using the target current value, the d-axis current value Id, the q-axis current value Iq, and the DC voltage sensor value Vdc, the current control unit 803 performs feedback control so that the d-axis current value Id and the q-axis current value Iq follow the target current value, and calculates three-phase duties Du, Dv, and Dw for the three phases in the PWM control. The duties Du, Dv, and Dw are input to the PWM signal generation unit 804.

The PWM signal generation unit 804 switches the signal to be output to the driver circuit 81 according to the operation state output from the state control unit 801. The PWM signal generation unit 804 includes a timer (not illustrated) therein, and generates a PWM signal pwm using the timer value and the duties Du, Dv, and Dw in the respective phases output from the current control unit 803 when the operation state is a PWM state. Then, the PWM signal generation unit 804 outputs the generated PWM signal pwm to the driver circuit 81.

On the other hand, when the operation state is a three-phase open state, a PWM signal pwm for turning off all the six power semiconductors 822 (see FIG. 3) in the power conversion circuit 82 is generated. When the operation state is a three-phase short-circuit state, a PWM signal pwm for turning off all the power semiconductors 822 of the upper arm and turning on all the power semiconductors 822 of the lower arm among the six power semiconductors 822 in the power conversion circuit 82, or a PWM signal pwm for turning on all the power semiconductors 822 of the upper arm and turning off all the power semiconductors 822 of the lower arm is generated.

Based on the d-axis current value Id, the q-axis current value Iq, the motor angular velocity ω0, and motor parameters R, Ld, Lq, and Φ, the DC current calculation unit 807 calculates a d-axis voltage value Vd and a q-axis voltage value Vq according to the following equation (2).

$$[ Mathematical formula 2 ]$$

$$[ \begin{matrix}{V}_{d} \\ {V}_{q}\end{matrix} ] = [ \begin{matrix}R + {PL}_{d} & - ω {L}_{q} \\ ω {L}_{d} & R + {PL}_{q}\end{matrix} ] [ \begin{matrix}{I}_{d} \\ {I}_{q}\end{matrix} ] + [ \begin{matrix}0 \\ \sqrt{\frac{3}{2}} ω ϕ\end{matrix} ] \qquad ( 2 )$$

In Equation (2), R represents a winding resistance value of the motor 9, Ld represents a d-axis inductance value of the motor 9, Lq represents a q-axis inductance value of the motor 9, ω represents an electrical angular velocity of the motor 9, and Φ represents a magnetic flux of the motor 9. The electrical angular velocity ω can be calculated by multiplying the motor angular velocity ω0 by the number of pole pairs of the motor. Note that P is a symbol representing differential calculation.

The motor parameters R, Ld, Lq, and Φ are set based on measurement results obtained by measuring characteristics of the motor 9 in advance. In addition, the winding resistance value R and the magnetic flux Φ also change depending on the temperature of the motor 9. Thus, in the present embodiment, the winding resistance value R and the magnetic flux Φ are corrected using the motor temperature sensor value Tm in order to improve calculation accuracy. Under the condition that the d-axis current value Id and the q-axis current value Iq are substantially constant, the influence of the differential term on the calculation result is small. Thus, the calculation of the differential term may be omitted in order to reduce the calculation processing.

Next, the DC current calculation unit 807 calculates a DC current calculation value Idc according to the following Equation (3) based on the calculated d-axis voltage value Vd and q-axis voltage value Vq, the d-axis current value Id, the q-axis current value Iq, and the DC voltage sensor value Vdc. Equation (3) is derived from the relationship in which DC power input to the power conversion circuit 82 is substantially equal to AC power output from the power conversion circuit 82. In Equation (3), the numerator=VdId+VqIq on the right side represents AC power output from the power conversion circuit 82. The DC current calculation unit 807 outputs the calculated DC current calculation value Idc to the output torque calculation unit 808 and the external control device 6.

$$[ Mathematical formula 3 ]$$

$${I}_{dc} = \frac{{V}_{d} {I}_{d} + {V}_{q} {I}_{q}}{{V}_{dc}} \qquad ( 3 )$$

In the calculation of the DC current calculation unit 807, the AC power is calculated using the d-axis current value Id and the q-axis current value Iq obtained by converting the actually measured AC current sensor values Iu, Iv, and Iw, the d-axis current value Id and the q-axis current value Iq, and the d-axis voltage value Vd and the q-axis voltage value Vq calculated from Equation (2). Therefore, even if the power conversion circuit 82 fails and is not able to output an AC voltage and an AC current according to the duties Du, Dv, and Dw output by the current control unit 803, the actually outputting AC power and the actually flowing DC current can be correctly calculated.

The output torque calculation unit 808 calculates the output torque τ output by the motor 9 based on the DC voltage sensor value Vdc, the DC current calculation value Idc, and the motor angular velocity ω0. The calculated output torque τ is output to the diagnosis unit 809 and the external control device 6.

The diagnosis unit 809 diagnoses a failure inside the power conversion device 8. When a failure is detected by diagnosis, the diagnosis unit 809 outputs the details about the failure location as a failure detection signal Sf to the state control unit 801 and the external failure notification device 7. For example, when the output torque t deviates from the target torque τs by a certain amount or more as a result of comparing the output torque τ with the target torque τs, the diagnosis unit 809 determines that there is a failure. Of course, the diagnosis performed by the diagnosis unit 809 is not limited thereto, and the diagnosis of the sensor and the power conversion circuit 82 is performed using various sensor values, but detailed description thereof will be omitted.

Meanwhile, in a case where it is desired to continue driving the vehicle 1 even after a failure occurs in the power conversion circuit 82, from the viewpoint of ensuring safety, a function of detecting an occurrence of any further failure and safely stopping the vehicle 1 is required. As described above, in the present embodiment, even when a failure occurs in the power conversion circuit 82, a DC current can be calculated correctly, and an output torque τ of the motor 9 can also be calculated correctly. Therefore, even after the failure, the diagnosis unit 809 can diagnose a deviation between the target torque τs and the output torque τ. In this manner, when another failure occurs after the failure of the power conversion circuit 82, the failure can be detected by the diagnosis unit 809. As a result, even after the failure of the power conversion circuit 82, it is possible to continue driving the vehicle 1 while degenerating some functions such as limp home.

In addition, in a case where another drive device such as an engine is mounted on the vehicle 1 that is a hybrid vehicle or the like, it is necessary to control output torques of the plurality of drive devices in a coordinated manner. In the present embodiment, even after a failure occurs in the power conversion circuit 82, the correct output torque t can be transmitted to the external control device 6. Therefore, even after the occurrence of the failure in the power conversion circuit 82, the control device 6 can continue the cooperative control with another drive device based on the output torque t.

### Second Embodiment

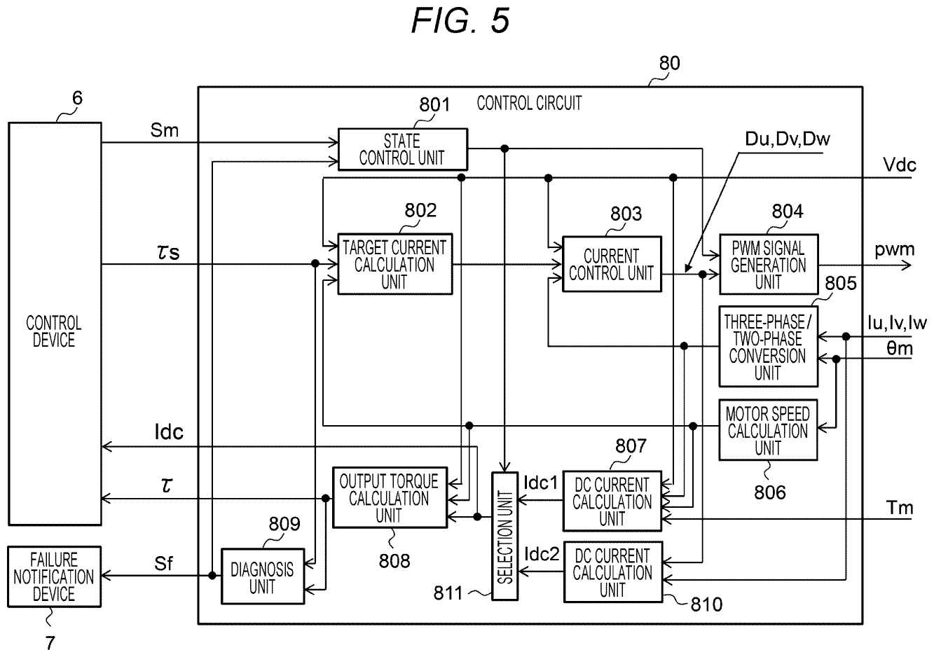

FIG. 5 is a diagram illustrating a second embodiment of the present invention, and is a control block diagram of the control circuit 80 similarly to that of FIG. 4 described above. The components other than the control circuit 80 are identical to those in the first embodiment. In addition, in FIG. 5, the same reference signs are given to components identical to those in the first embodiment, and differences will be mainly described below.

In the second embodiment, the control circuit 80 further includes a DC current calculation unit 810 and a selection unit 811 in addition to the components illustrated in FIG. 4. The DC current calculation unit 807 calculates a DC current calculation value Idc according to Equations (2) and (3), similarly to that in the first embodiment. On the other hand, unlike the DC current calculation unit 807, the DC current calculation unit 810 calculates a DC current calculation value Idc according to the following Equation (4) using the AC current sensor values Iu, Iv, and Iw measured by the AC current sensor 84.

$$[ Mathematical formula 4 ]$$

$${I}_{dc} = {D}_{u} {I}_{u} + {D}_{v} {I}_{ν} + {D}_{w} {I}_{w} \qquad ( 4 )$$

In Equation (4), Du, Dv, and Dw are duties in the U phase, the V phase, and the W phase generated by the current control unit 803. The AC current sensor values Iu, Iv, and Iw and the duties Du, Dv, and Dw are input to the DC current calculation unit 810, and the DC current calculation unit 810 calculates a DC current calculation value Idc based on Equation (4). Hereinafter, the DC current calculation value calculated by the DC current calculation unit 807 is represented by reference sign Idc1, and the DC current calculation value calculated by the DC current calculation unit 810 is represented by reference sign Idc2.

Idc1 is input from the DC current calculation unit 807 to the selection unit 811 as a DC current calculation value, and Idc2 is input from the DC current calculation unit 810 to the selection unit as a DC current calculation value. In addition, the operation state (e.g., a PWM state, a three-phase short-circuit state, or a three-phase open state) of the power conversion device 8 is input from the state control unit 801 to the selection unit 811. The selection unit 811 selects one of the DC current calculation values Idc1 and Idc2 according to the operation state output from the state control unit 801, and outputs the selected one as a DC current calculation value Idc to the output torque calculation unit 808 or the external control device 6.

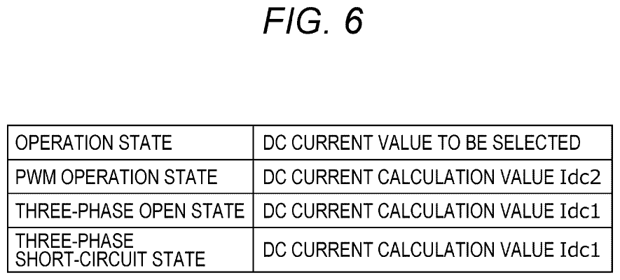

FIG. 6 is a diagram illustrating a correspondence between an operation state and a DC current calculation value to be selected by the selection unit 811. When the power conversion device 8 is in a PWM operation state, the DC current calculation value Idc2 is selected. When the power conversion device 8 is in a three-phase open state or a three-phase short-circuit state, the DC current calculation value Idc1 is selected.

As shown in Equation (2), the motor parameters R, Ld, Lq, and Φ are used for the calculation of the DC current calculation unit 807. Therefore, the DC current calculation value Idc1 is likely to be affected by parameter deviations from the actual motor constants of the motor 9, and the accuracy of the DC current calculation value Idc1 may be inferior to that of the DC current calculation value Idc2. Therefore, when the power conversion device 8 is in the PWM operation state, the DC current calculation value Idc2, which has higher calculation accuracy, is used.

When the power conversion device 8 is in the three-phase open state, all the six power semiconductors 822 (see FIG. 3) are turned off. Therefore, the duties Du, Dv, and Dw in Equation (4) are all 0, and the DC current calculation value Idc2 is 0 [A]. In addition, when the power semiconductors 822 of the upper arm are turned off in the three-phase short-circuit state, the duties Du, Dv, and Dw are all 0, and the DC current calculation value Idc2 is 0 [A], as in the three-phase open state. On the other hand, when the power semiconductors 822 of the upper arm are turned on in the three-phase short-circuit state, the duties Du, Dv, and Dw are all 1, and the DC current value is the sum of AC current sensor values Iu, Iv, and Iw. However, according to Kirchhoff's law, the sum of the three-phase AC currents is 0 [A], and thus, the DC current calculation value Idc2 is 0 [A] in this case as well.

In this manner, in the three-phase open state and the three-phase short-circuit state, the DC current calculation value Idc2 is always 0 [A]. Therefore, if a small amount of DC current is actually flowing, the DC current calculation value Idc1 may be more accurate. Therefore, in the three-phase open state and in the three-phase short-circuit state, the DC current calculation value Idc1, which is a calculation result of the DC current calculation unit 807, is used. In this manner, by providing the two DC current calculation units 807 and 810 and selecting and using a more accurate DC current calculation value according to the operation state of the power conversion device 8, a correct DC current value can be used.

Meanwhile, when the DC current calculation value to be used is switched by the selection unit 811, if there is a large difference between the before-switching DC current calculation value and the after-switching DC current calculation value, the switching operation may affect the output torque calculation. Therefore, when the difference between the before-switching DC current calculation value and the after-switching DC current calculation value is larger than a predetermined value, the selection unit 811 switches to the DC current calculation value Idc1 or Idc2 after outputting a value between the DC current calculation value Idc1 and the DC current calculation value Idc2, thereby reducing the influence of the switching operation.

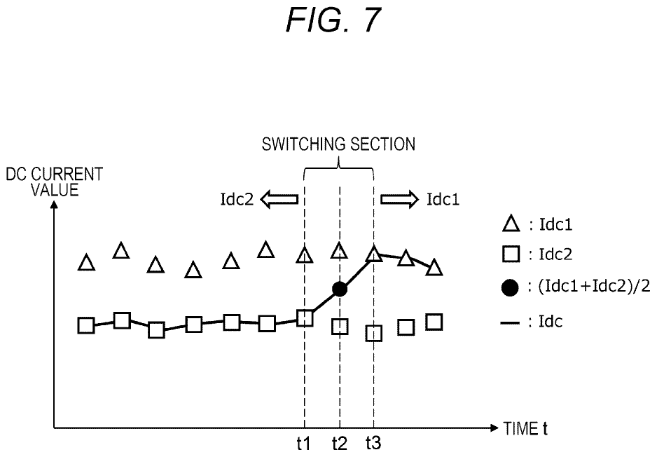

FIG. 7 is a diagram illustrating an example of a switching operation performed by the selection unit 811. In the example of the switching operation illustrated in FIG. 7, the operation state input until timing t1 is the PWM operation state, and the operation state is switched to the three-phase short-circuit state or the three-phase open state at timing t2. Until the timing t1, the DC current calculation value Idc2, which is suitable for the PWM operation state, is selected.

At the next timing t2, the operation state changes to the three-phase short-circuit state or the three-phase open state, but the selection unit 811 does not immediately switch the DC current calculation value Idc to the DC current calculation value Idc1, and outputs an average value (Idc1+Idc2)/2 of the DC current calculation value Idc1 and the DC current calculation value Idc2 as the DC current calculation value Idc. Then, at the next timing t3, the DC current calculation value Idc is switched to the DC current calculation value Idc1. In this manner, by performing the switching operation stepwise so as to reduce the difference between before and after the switching, the influence of the switching operation can be reduced.

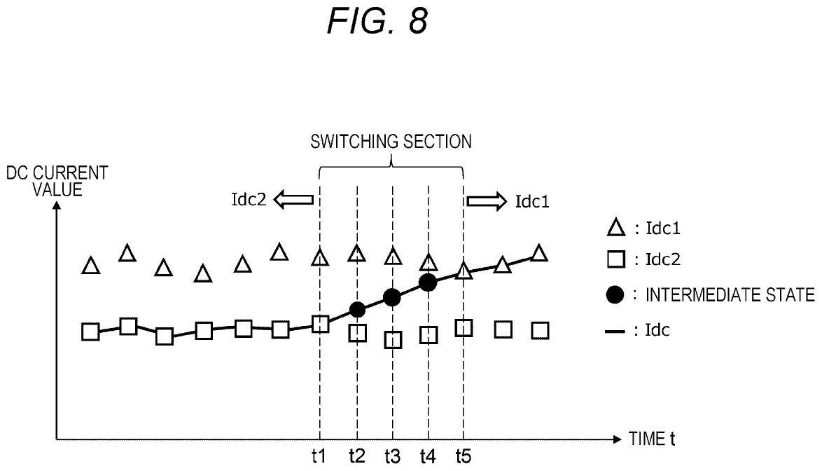

Note that, in the example illustrated in FIG. 7, the switching is performed as Idc2→(Idc1+Idc2)/2→Idc1, but the switching mode is not limited thereto. For example, more stages may be provided to transition from Idc2 to Idc1. Specifically, as illustrated in FIG. 8, the DC current value to be used may be switched from the DC current calculation value Idc2 to the DC current calculation value Idc1 while changing the ratio between Idc1 and Idc2 in multiple stages such as t1(0:10)→t2(2:8)→t3(5:5)→t4(8:2)→t5 (10:0). As a result, the influence of the switching operation can be further suppressed.

### Third Embodiment

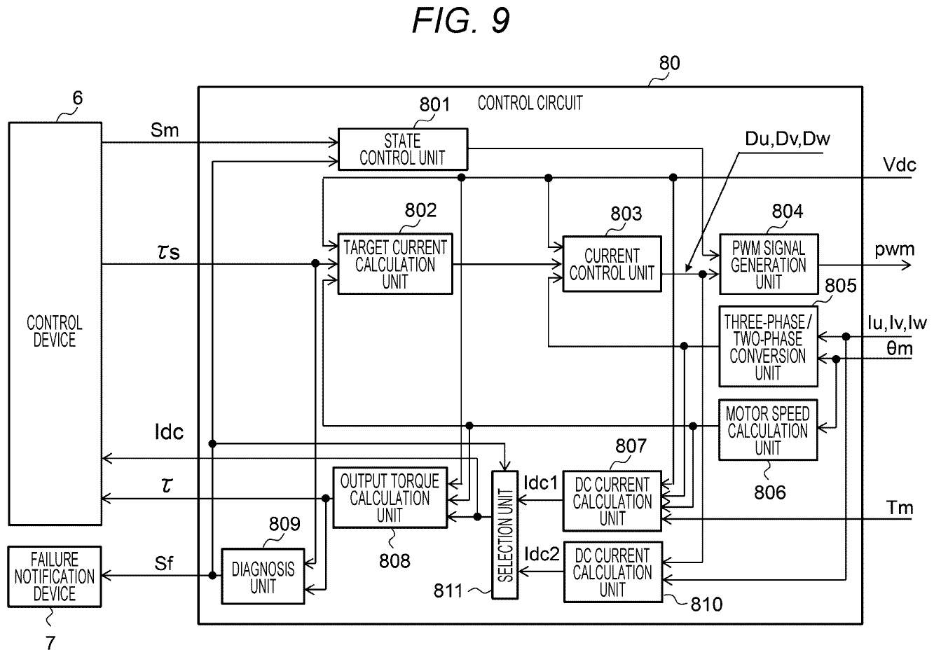

FIG. 9 is a diagram illustrating a third embodiment of the present invention, and is a control block diagram of the control circuit 80. The components other than the control circuit 80 are identical to those in the second embodiment. In the configuration of the control circuit 80 illustrated in FIG. 5 of the second embodiment described above, the operation state (e.g., a PWM state, a three-phase short-circuit state, or a three-phase open state) of the power conversion device 8 is input from the state control unit 801 to the selection unit 811. On the other hand, in the control circuit 80 illustrated in FIG. 9, information regarding a failure state inside the power conversion device 8 is input from the diagnosis unit 809 to the selection unit 811. Other configurations are similar to those of the control circuit 80 illustrated in FIG. 5 and described above. Hereinafter, differences from the second embodiment will be mainly described.

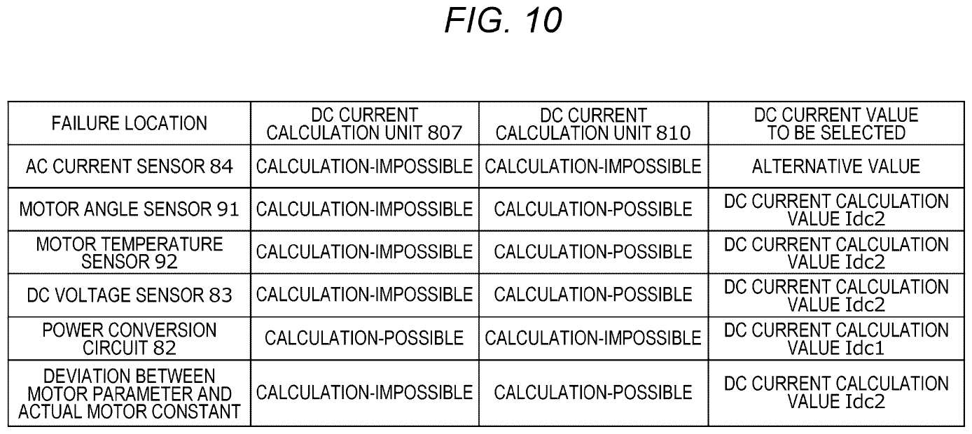

The DC current calculation values Idc1 and Idc2 are input from the DC current calculation units 807 and 810, respectively, to the selection unit 811, and the failure state is input from the diagnosis unit 809 to the selection unit 811 as described above. The selection unit 811 selects any one of the DC current calculation value Idc1, the DC current calculation value Idc2, and another alternative value according to the input failure state. Then, the selection unit 811 outputs the selected value as the DC current calculation value Idc to the output torque calculation unit 808 and the external control device 6. FIG. 10 is a diagram for explaining the operation of the selection unit 811. In FIG. 10, whether the DC current calculation units 807 and 810 are calculation-possible or calculation-impossible and a value to be selected are described according to a failure location.

(Case where Power Conversion Circuit 82 has Failed)

First, a case where the power conversion circuit 82 has failed will be described. In a case where the power conversion circuit 82 has failed, in the calculation of the DC current calculation unit 810, the duties Du, Dv, and Dw in Equation (4) deviate from the actual on/off states of the power semiconductors 822, and thus, the DC current calculation value Idc2 is not a correct value. On the other hand, the DC current calculation value Idc1, which is a calculation result of the DC current calculation unit 807, is a correct value because it is based on the actually measured AC current sensor values Iu, Iv, and Iw. Therefore, when the power conversion circuit 82 fails, the selection unit 811 selects and outputs the DC current calculation value Idc1.

(Case where Sensor 91, 92, or 83 has Failed and Case where Deviation of Motor Parameter has Occurred)

Next, a case where the motor angle sensor 91, the motor temperature sensor 92, or the DC voltage sensor 83 has failed or a case where the motor parameter R, Ld, Lq, or Φ deviated from the actual one will be described. In Equation (1) for calculating a d-axis current value Id and a q-axis current value Iq, an electrical angle θ is calculated from the motor angle sensor value θm measured by the motor angle sensor 91. In Equation (2) for calculating a d-axis voltage value Vd and a q-axis voltage value Vq, an electrical angular velocity ω based on the motor parameters R, Ld, Lq, and Φ and the motor angle sensor value Om is used. At that time, the winding resistance value R and the magnetic flux Φ are corrected using the motor temperature sensor value Tm. In Equation (3) for calculating a DC current calculation value Idc, the DC voltage sensor value Vdc is used.

In this manner, in the calculation of the DC current calculation value Idc1, the measurement results of the motor angle sensor 91, the motor temperature sensor 92, and the DC voltage sensor 83 and the motor parameters R, Ld, Lq, and Φ are used. Therefore, when the motor angle sensor 91, the motor temperature sensor 92, or the DC voltage sensor 83 has failed, or when the motor parameter R, Ld, Lq, or Φ deviates from the actual motor constant, the DC current calculation unit 807 cannot perform correct calculation. In such a case, the selection unit 811 selects and outputs the DC current calculation value Idc2 input from the DC current calculation unit 810.

(Case where AC Current Sensor 84 has Failed)

The AC current sensor values Iu, Iv, and Iw are used by both the DC current calculation unit 807 and the DC current calculation unit 810 as shown in Equations (1) and (4). Therefore, if the AC current sensor 84 fails, both the DC current calculation units 807 and 810 cannot correctly calculate DC current calculation values. Therefore, when the AC current sensor 84 fails, the selection unit 811 selects and outputs a preset alternative value.

Regarding the alternative value, it is determined in advance that the alternative value is output from the selection unit 811 when the calculation results of the DC current calculation units 807 and 810 are not reliable. In addition, as a process of outputting the alternative value, reliability information may be output together with the DC current calculation value (Idc1 or Idc2) as a set. As the reliability information, for example, 1 is output when the DC current calculation value is reliable, and 0 is output when the DC current calculation value is not reliable.

In this manner, by setting in advance the alternative value in case DC current values cannot be correctly calculated, the output torque calculation unit 808 and the external control device 6 can determine that the calculation result is not reliable when the alternative value is output. Then, in the subsequent process, it is possible to take measures such as not using a DC current calculation value.

As described above, in the third embodiment, the selection unit 811 selects and outputs either the calculation result of the DC current calculation unit 807 or 810 or the alternative information according to the failure state of the power conversion device 8. As a result, a DC current calculation value can be appropriately used according to the failure state. Furthermore, in a case where the DC current calculation values Idc1 and Idc2 cannot be calculated as in a case where the AC current sensor 84 fails, it is possible to prevent the use of the unreliable DC current calculation value by outputting the alternative value from the selection unit 811.

Note that, in each of the above-described first to third embodiments, some or all of the above-described configurations, functions, processing units, and the like may be realized in hardware, for example, by designing them as integrated circuits. Further, each of the above-described configurations, functions, and the like may be realized in software by a processor interpreting and executing a program that realizes each function. Information such as programs, tables, and files for realizing the respective functions can be stored in a recording device such as a memory, a hard disk, or a solid state drive (SSD), or a recording medium such as an IC card or a DVD.

According to the first to third embodiments of the present invention described above, the following effects are achieved.

(C1) As illustrated in FIGS. 2 and 4, etc., a power conversion device 8 includes: a power conversion circuit 82 that converts DC power into AC power through PWM control, and outputs three-phase AC currents to a motor 9; a three-phase/two-phase conversion unit 805 that converts the three-phase AC currents Iu, Iv, and Iw into dq-axis currents (d-axis current Id and q-axis current Iq); a DC voltage detection unit (DC voltage sensor 83) that detects a DC voltage value Vdc of the DC power; a first compute unit (DC current calculation unit 807) that calculates dq-axis voltages (d-axis voltage Vd and q-axis voltage Vq) based on motor parameters of the motor 9 and the dq-axis currents Id and Iq, and calculates a first DC current value (DC current calculation value Idc1) of the DC power based on the dq-axis voltages Vd and Vq, the dq-axis currents Id and Iq, and the DC voltage value Vdc.

As described above, since the DC current calculation value Idc1 is calculated based on the motor parameters, the actually measured three-phase AC currents Iu, Iv, and Iw, and the DC voltage value Vdc, a correct DC current value can be calculated during normal operation (during PWM operation, during three-phase open operation, or during three-phase short-circuit operation) or even when the power conversion circuit 82 has failed. As a result, any process performed using a DC current value can be appropriately performed.

(C2) In (C1), as illustrated in FIG. 4, etc., the DC current calculation unit 807 calculates the DC current calculation value Idc1 at least when a switching element (power semiconductor 822) provided in the power conversion circuit 82 has failed. In this manner, when the power semiconductor 822 provided in the power conversion circuit 82 has failed, the DC current calculation unit 807 calculates the DC current calculation value Idc1, thereby making it possible to calculate a correct DC current value.

(C3) In (C1), as illustrated in FIGS. 5 and 9, etc., the power conversion device 8 further includes: an AC current detection unit (AC current sensor 84) that detects AC current values (AC current sensor values Iu, Iv, and Iw) of the three-phase AC currents; and a second compute unit (DC current calculation unit 810) that calculates a second DC current value (DC current calculation value Idc2) of the DC power based on three-phase duties Du, Dv, and Dw in the PWM control the AC current sensor values Iu, Iv, and Iw, and one of the DC current calculation values Idc1 and Idc2 is selected and used according to an operation state and/or a failure state of the power conversion device 8.

Therefore, when the DC current calculation value Idc1 cannot be correctly calculated (when the motor angle sensor 91, the motor temperature sensor 92, or the DC voltage sensor 83 has failed, or when a motor parameter deviates from the actual one) or when the calculation accuracy is poor (PWM operation), the DC current calculation value Idc2 is selected and used. On the other hand, when the DC current calculation value Idc2 cannot be correctly calculated (in a three-phase open state, in a three-phase short-circuit state, or when the power conversion circuit 82 has failed), the DC current calculation value Idc1 is selected and used. In this manner, by selecting and using one of the DC current calculation values Idc1 and Idc2 according to the operation state and/or the failure state of the power conversion device 8, a DC current value can be correctly calculated in various states.

(C4) In (C3), as illustrated in FIGS. 5 and 6, etc., for example, when the operation state of the power conversion device 8 is a three-phase short-circuit state or in a three-phase open state, the power conversion device 8 selects and uses the DC current calculation value Idc1 calculated by the DC current calculation unit 807 because the DC current calculation unit 810 cannot perform a correct calculation.

(C5) In (C3), as illustrated in FIGS. 9 and 10, etc., for example, when the power conversion circuit 82 has failed, the power conversion device 8 selects and uses the DC current calculation value Idc1 calculated by the DC current calculation unit 807 because the DC current calculation unit 810 cannot perform a correct calculation.

(C6) In (C3), as illustrated in FIGS. 2, 9, and 10, etc., the motor 9 includes a motor angle sensor 91 that measures a motor rotation angle (motor angle sensor value θm), and a motor temperature sensor 92 that measures a motor temperature (motor temperature sensor value Tm), and when any of the DC voltage detection unit (DC voltage sensor 83), the motor angle sensor 91, and the motor temperature sensor 92 has failed, the power conversion device 8 selects and uses the DC current calculation value Idc2 calculated by the DC current calculation unit 810 because the DC current calculation unit 807 cannot perform a correct calculation in the power conversion device 8.

(C7) In (C3), as illustrated in FIGS. 9 and 10, etc., when the AC current detection unit (AC current sensor 84) has failed, the power conversion device 8 uses alternative information for notifying that the DC current calculation values Idc1 and Idc2 are not reliable, rather than using the DC current calculation values Idc1 and Idc2, because the DC current calculation units 807 and 810 cannot correctly calculate DC current values. For example, instead of the DC current calculation values Idc1 and Idc2, an alternative value (a value defined as unreliable) is output from the selection unit 811.

(C8) In (C3), as illustrated in FIG. 7, etc., when a DC current value to be used is switched from the DC current calculation value Idc1 to the DC current calculation value Idc2 or from the DC current calculation value Idc2 to the DC current calculation value Idc1 according to the operation state and/or failure state of the power conversion device 8, the DC current value to be used transitions to the after-switching DC current value after transitioning to a third DC current value between the DC current calculation value Idc2 and the DC current calculation value Idc1.

For example, as in the example illustrated in FIG. 7, the third DC current value is set to an average value thereof=(Idc1+Idc2)/2. By transitioning the DC current value to be used in this manner when performing switching, the DC current value gradually changes over time when performing the switching, so that the influence of the switching operation can be suppressed.

(C9) Furthermore, in (C8), as illustrated in FIG. 8, a plurality of third DC current values having different magnitudes may be set at timings t2 to t4 of the switching section, and the DC current value to be used may transition from the before-switching DC current calculation value Idc1 to the after-switching DC current calculation value Idc2 in a stepwise manner. In FIG. 8, the ratios between Idc1 and Idc2 at t2, t3, and t4 are set as (2:8), (5:5), and (8:2), respectively. In this manner, by transitioning the DC current value to be used from the DC current calculation value Idc2 to the DC current calculation value Idc1 in multiple stages, it is possible to make the change in the DC current value between the timings more gradual. As a result, the influence of the switching operation can be suppressed.

(C10) As illustrated in FIGS. 2 and 3, etc., a drive device 2 includes a motor 9, and the above-described power conversion device 8 according to (C1) that converts DC power into AC power through PWM control, and supplies three-phase AC currents to the motor 9. As described in (C1), the power conversion device 8 included in the drive device 2 can calculate a correct DC current value during normal operation (during PWM operation, during three-phase open operation, or during three-phase short-circuit operation) or even when the power conversion circuit 82 has failed. As a result, any process performed using a DC current value can be appropriately performed in the drive device 2.

The embodiments described above are merely examples, and the present invention is not limited thereto as long as the features of the invention are not impaired. Other aspects conceivable within the technical spirit of the present invention also fall within the scope of the present invention. In addition, a part of the configuration of one embodiment may be replaced with the configuration of another embodiment, and the configuration of one embodiment may be added to the configuration of another embodiment. For example, by inputting not only the failure state from the diagnosis unit 809 but also the operation state from the state control 801 as illustrated in FIG. 5 to the selection unit 811 of FIG. 9, the selection unit 811 may perform a selection process based on both the failure state and the operation state. In addition, with respect to a part of the configuration of each embodiment, it is possible to perform addition of another configuration, deletion, or replacement.

### REFERENCE SIGNS LIST

1 vehicle
2 drive device
5 DC power supply
6 control device
7 failure notification device
8 power conversion device
9 motor
80 control circuit
81 driver circuit
82 power conversion circuit
83 DC voltage sensor
84 AC current sensor
91 motor angle sensor
92 motor temperature sensor
s801 state control unit
802 target current calculation unit
803 current control unit
804 PWM signal generation unit
805 three-phase/two-phase conversion unit
806 motor speed calculation unit
807, 810 DC current calculation unit
808 output torque calculation unit
809 diagnosis unit
811 selection unit
822 power semiconductor

1. A power conversion device comprising:
a power conversion circuit that converts DC power into AC power through PWM control, and outputs three-phase AC currents to a motor;
a three-phase/two-phase conversion unit that converts the three-phase AC currents into dq-axis currents;
a DC voltage detection unit that detects a DC voltage value of the DC power; and
a first compute unit that calculates dq-axis voltages based on motor parameters of the motor and the dq-axis currents, and calculates a first DC current value of the DC power based on the dq-axis voltages, the dq-axis currents, and the DC voltage value.

2. The power conversion device according to claim 1, wherein
the first compute unit calculates the first DC current value at least when a switching element provided in the power conversion circuit has failed.

3. The power conversion device according to claim 1, further comprising:
an AC current detection unit that detects AC current values of the three-phase AC currents; and
a second compute unit that calculates a second DC current value of the DC power based on three-phase duties in the PWM control and the AC current values,
wherein one of the first DC current value and the second DC current value is selected and used according to an operation state and/or a failure state of the power conversion device.

4. The power conversion device according to claim 3, wherein
when the operation state is a three-phase short-circuit state or a three-phase open state, the first DC current value calculated by the first compute unit is selected and used.

5. The power conversion device according to claim 3, wherein
when the power conversion circuit has failed, the first DC current value calculated by the first compute unit is selected and used.

6. The power conversion device according to claim 3, wherein
the motor includes a motor angle sensor that measures a motor rotation angle, and a motor temperature sensor that measures a motor temperature, and
when any of the DC voltage detection unit, the motor angle sensor, and the motor temperature sensor has failed, the second DC current value calculated by the second compute unit is selected and used.

7. The power conversion device according to claim 3, wherein
when the AC current detection unit has failed, alternative information for notifying that the first and second DC current values are not reliable is used, rather than using the first and second DC current values.

8. The power conversion device according to claim 3, wherein
when a DC current value to be used is switched from the first DC current value to the second DC current value or from the second DC current value to the first DC current value according to the operation state and/or the failure state of the power conversion device,
the DC current value to be used transitions to the after-switching DC current value after transitioning to a third DC current value between the first DC current value and the second DC current value.

9. The power conversion device according to claim 8, wherein
a plurality of the third DC current values having different magnitudes are set, and the DC current value to be used transitions from the before-switching DC current value to the after-switching DC current value in a stepwise manner.

10. A drive device comprising:
a motor; and
the power conversion device according to claim 1 that converts DC power into AC power through PWM control, and supplies three-phase AC currents to the motor.
